(19) United States
(12) Patent Application Publication
(10) Pub. No.: US 2005/0230653 A1
(43) Pub. Date: Oct. 20, 2005

(54) Low pressure stem gas seal

(75) Inventors: Grant R. Thompson, Tulsa, OK (US); Aaron T. Jackson, Broken Arrow, OK (US)

Correspondence Address: DUANE, MORRIS, LLP, 3200 SOUTHWEST FREEWAY, SUITE 3150, HOUSTON, TX, 77027, US

(73) Assignee: Baker Hughes Incorporated

(21) Appl. No.: 11/106,298

(22) Filed: Apr. 14, 2005

Related U.S. Application Data
(60) Provisional application No. 60/562,152, filed on Apr. 14, 2004.

(51) Int. Cl. F16K 31/44

(52) U.S. Cl. 251/214

(57) ABSTRACT

A backup stem seal for a gate valve retains pressure in the body when the valve is in the closed position. The backup seal is secondary to the main stem seal assembly in the bonnet. It features metal-to-metal contact between surfaces that are radially oriented or sloping and further can contain a retaining groove for a seal ring in one or both the opposed metal-to-metal surfaces. The groove can be formed to better retain the ring from damage from flowing fluids when the valve is open. A passage through the bonnet may be used to test for leakage past such seal. The backup seal allows maintenance of the main stem seal without removing the valve from service.

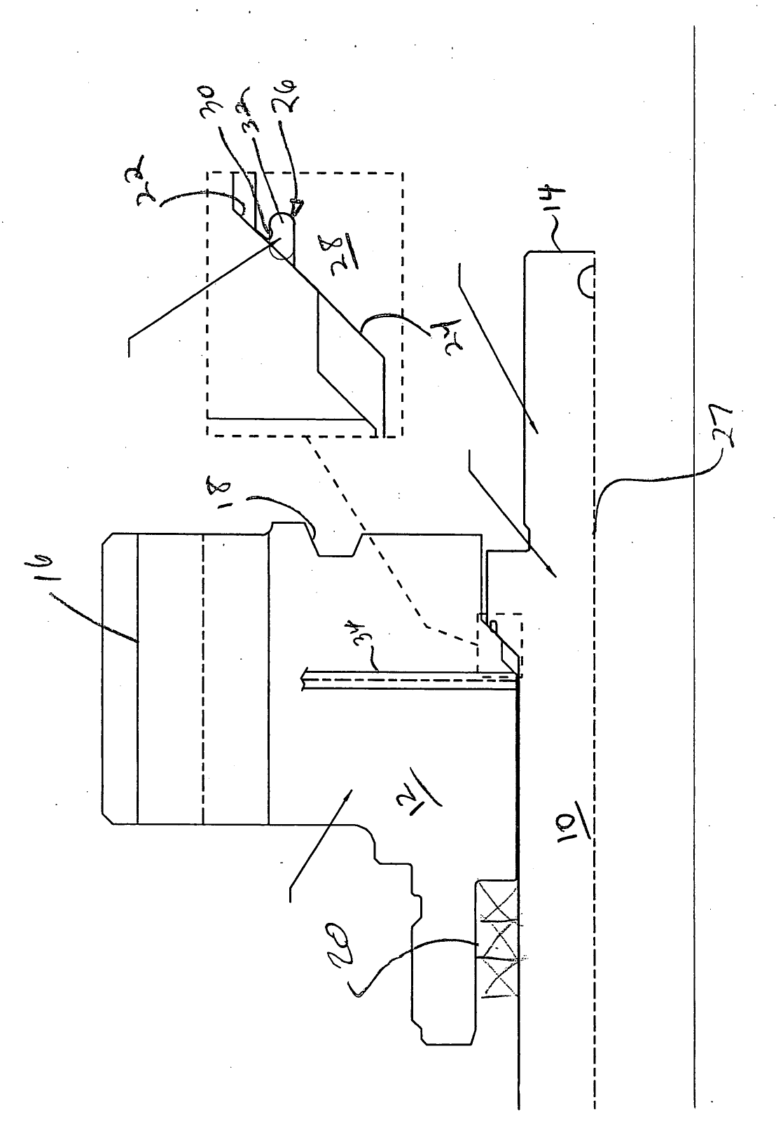

### PRIORITY INFORMATION

This application claims the benefit of U.S. Provisional Application No. 60/562,152, filed on Apr. 14, 2004.

### FIELD OF THE INVENTION

The field of this invention relates to valve stem seals and more particularly to back up stem seals for gate valves designed to contain fluid pressures in the valve body.

### BACKGROUND OF THE INVENTION

Gate valves are in common use in the oil and gas industries. The American Petroleum Institute (API) has standards that apply to gate valves, notably Standard 6A. Typically, a gate valve features a gate that is operable in a body to go up against a seat to close the valve. A stem is attached to the gate to move the gate up and down. The stem can be manually operated, such as with a hand wheel or the valve can be automatically operated by an actuator controlled by a control system sensing a variable in the system where the gate valve is mounted. Gate valves are frequently used for open or closed service and are not the preferred design for throttling applications like a choke, where other valve styles dominate.

The stem that is connected to the gate at one end extends through a bonnet at the other end. The bonnet is typically bolted to the valve housing to close off the internal cavity where the gate goes up and down between a valve inlet and a valve outlet. Typically, a seal assembly is mounted around the stem in a gland created by a counter-bore in the bonnet in the vicinity of where the stem extends through it. This seal assembly is the primary stem seal found in all bonnet/actuator assemblies used with gate valves.

For reasons of customer demand and/or industry standards, secondary seals have been employed in gate valves. In some designs, the packing around the stem is provided as two interacting assemblies that move relatively with respect to one another, so that if one fails, the other will serve as backup. One example is U.S. Pat. No. 4,489,916. Another example of backup stacks of packing rings is U.S. Pat. No. 4,379,557. In some designs the backup seal is a series of Belleville washers that don't spring into a sealing relation with the bonnet or the stem unless a surrounding heat source, such as a fire, releases the washers into a backup sealing position. An example of such a design is U.S. Pat. No. 4,082,105.

Still other designs rely on metal to metal sealing between a portion of the stem assembly and the bonnet as a backup seal if the main stem seal is damaged in a fire. U.S. Pat. No. 4,568,062 shows one such design using a backseat flange 56 having a metallic seating surface 56a that contacts a radial surface 62 in the bonnet after a failure caused by fire drives the stem an incremental amount to achieve the stated sealing contact. Optionally, the backseat flange 56 can have o-rings 64 and 66 that also engage surfaces 62 and 60 when fusible ring 52 melts to allow the stem 30 to be pushed up by spring 68.

U.S. Pat. No. 6,450,477 shows a metal-to-metal contact of a tapered surface 112 on the stem with the bonnet in the event of a fire to act as a secondary seal and to act as a travel stop in normal operation.

The problem with even the most recent designs is the difficulty in obtaining a low-pressure backup seal to the main stem seal during normal operations when the valve is in its closed position. This is a requirement by some end users. The backup seal is frequently expected to hold back at least 200 pounds per square inch of gas pressure in the valve body. The prior metal-to-metal seals in this service often proved problematic in achieving sealing contact. The metal-to-metal mating surfaces required precision machining and lapping to improve their performance. Another problem with prior designs of backup seals that used o-rings such as U.S. Pat. No. 4,568,062 is that in normal operation of the valve with it in the open position, the rushing fluid flow, particularly when in gas service, was sufficient to dislodge the o-ring from its retaining groove. In this prior art reference the sealing is accomplished by a hoped for metal-to-metal contact with the o-rings acting as backup. One reason for this can be that exposure to flowing fluid as well as temperature cycles over time could act to dislodge the o-rings to the point where they could not serve in a sealing capacity.

What is needed is a design that reliably provides a backup seal for the stem through the bonnet whereby the sealing surfaces can properly come into sealing contact. At least one seal ring can be incorporated in the mating surfaces and so mounted so as to resist forces that may try to dislodge it from its position during normal valve operations and particularly when there is flow through the valve. The mounting groove for the seal ring to assist in retaining it in place is another feature of the present invention. These and other features of the present invention will become more readily apparent to those skilled in the art from a review of the description of the preferred embodiment and the claims that appear below.

### SUMMARY OF THE INVENTION

A backup stem seal for a gate valve retains pressure in the body when the valve is in the closed position. The backup seal is secondary to the main stem seal assembly in the bonnet. It features metal-to-metal contact between surfaces that are radially oriented or sloping and further can contain a retaining groove for a seal ring in one or both the opposed metal-to-metal surfaces. The groove can be formed to better retain the ring from damage from flowing fluids when the valve is open. A passage through the bonnet may be used to test for leakage past such seal. The backup seal allows maintenance of the main stem seal without removing the valve from service.

### BRIEF DESCRIPTION OF THE DRAWING

The Figure illustrates the stem in the valve closed position indicating that the backup seal assembly is engaged and showing an enlarged view of the backup seal area.

### DETAILED DESCRIPTION OF THE PREFERRED EMBODIMENT

Referring to the Figure, the stem 10 is shown extending through the bonnet 12. The stem 10 has a lower end 14, where the gate (not shown) is attached. The bonnet 12 is secured to the valve body (not shown) through bolts (not shown) extending through boltholes 16. A groove 18 holds a seal (not shown) to allow the bonnet 12 to be sealed to the valve body. A main stem seal 20 is held in a known manner between the stem 10 and the bonnet 12.

As shown in the enlarged view, bonnet 12 has a tapered surface 22 that comes into contact with a mating surface 24 which may or may not be parallel. While the orientation of surfaces 22 and 24 is shown as oblique to the axis 27 of the stem 10, those skilled in the art will appreciate that a perpendicular orientation is also envisioned by the present invention. A generally U-shaped groove 26 is shown in surface 22. Although one groove 26 is shown those skilled in the art will appreciate that more than one groove can be used and that a groove or grooves 26 can appear on surface 22 and/or surface 24 on stem projection 28.

An internal protrusion 30 that can take a variety of shapes and locations with the shown groove 26 is advantageous in retaining the seal ring 32 in groove 26. There can be one or move such protrusions 30 in the groove 26 on one or both sides. Yet other techniques in the configuration of the groove 26 can be used to aid retention of the ring 32 therein. The groove can have different cross-sectional shapes such as trapezoidal, as one example, so that it can better hold the ring 32 in the groove 26 akin to a dovetail type of connection. It is preferred that some portion of the ring 32 extend beyond surface 22, for example, so that when the stem is brought to the valve closed position there is circumferential contact with the opposing surface 24 with internal pressure built up in the ring 32. The preferred material for the ring for many circumstances is a combination of Teflon® with PEEK. Other materials, including elastomers can be used depending on the thermal requirements and the chemical resistance required by the particular service.

Those skilled in the art will appreciate that the present invention allows the gate valve to retain gas pressures within the body with the valve closed between contacting surfaces 22 and 24. The use of the ring 32 compensates for minor surface misalignments to ensure a seal. The shape of the retaining groove helps to hold on to the ring 32 when the valve is in the open position and flow moves quickly past the mounting location for the ring 32. The mating surfaces can have a radial or oblique orientation with respect to axis 27. One or more rings 32 can be used mounted in a respective groove 26, in either or both surfaces 22 and/or 24. An access passage 34 extends through bonnet 12 to allow checking if there is a secondary seal intact. Maintenance on the primary seal 20 can be attempted with there being a seal between surfaces 22 and 24 and low gas pressure in the order of about 200 pounds per square inch in the valve body. However, it is preferred to bleed all pressure off the valve body before attempting a repair of seal 20. Additionally, ring 32 can be in one piece or multiple pieces such as a capped o-ring and can be made from one material or combinations that extend uniformly or non-uniformly.

It is to be understood that this disclosure is merely illustrative of the presently preferred embodiments of the invention and that no limitations are intended other than as described in the appended claims.

1. A valve stem seal assembly, comprising:
a valve body having a closure member movable therein and secured to a stem that extends from a bonnet mounted to said body, said stem movable in and out of said body through said bonnet;
a first seal around said stem fixedly mounted to said bonnet;
said bonnet comprising a backup sealing surface and said stem comprising a mating sealing surface, whereupon exclusively by virtue of movement of said stem through said bonnet said sealing surfaces are brought together.

2. The assembly of claim 1, wherein:
said mating sealing surface is integral to said stem.

3. The assembly of claim 1, wherein:
at least one of said sealing surfaces further comprises a groove and a sealing ring shaped member mounted to and protruding from said groove.

4. The assembly of claim 3, wherein:
said groove is shaped to retain said ring shaped member after said ring shaped member is inserted in said groove.

5. The assembly of claim 4, wherein:
said groove comprises at least one indentation to squeeze said ring shaped member to retain it in said groove.

6. The assembly of claim 1, wherein:
said mating sealing surface comprises a radially extending surface from said stem.

7. The assembly of claim 6, wherein:
said stem comprises a longitudinal axis and said mating sealing surface is disposed in a plane perpendicular to said longitudinal axis.

8. The assembly of claim 6, wherein:
said stem comprises a longitudinal axis and said mating sealing surface is disposed in a plane oblique to said longitudinal axis.

9. The assembly of claim 1, wherein:
said sealing surfaces are brought together when said closure member is in the valve closed position.

10. The assembly of claim 9, wherein:
said sealing surfaces, when in contact hold pressure in said body of as low as 200 pounds per square inch.
